(19) United States
(12) Patent Application Publication
(10) Pub. No.: US 2026/0095359 A1
(43) Pub. Date: Apr. 2, 2026

(54) SOUNDING REFERENCE SIGNAL DESIGN AND SIGNALING IN CELLULAR COMMUNICATION SYSTEMS

(71) Applicant: Samsung Electronics Co., Ltd., Suwon-si (KR)

(72) Inventors: Soheil Rostami, Carrollton, TX (US); Ahmad AlAmmouri, Plano, TX (US); Shouvik Ganguly, Frisco, TX (US); Young Han Nam, Plano, TX (US)

(21) Appl. No.: 19/340,821

(22) Filed: Sep. 25, 2025

Related U.S. Application Data
(60) Provisional application No. 63/702,260, filed on Oct. 2, 2024.

(51) Int. Cl. H04L 27/26; H04L 5/00

(52) U.S. Cl. CPC H04L 27/261; H04L 5/0044; H04L 27/26536

(57) ABSTRACT

Apparatuses and methods for a sounding reference signal design and signaling in cellular communication systems. A method of a UE in a wireless communication system includes: receiving, from a base station (BS), a radio resource control (RRC) signal including first RRC parameters; identifying, based on the first RRC parameters, an aggregation flag indicating whether to enable sounding reference signal (SRS) slot aggregation; receiving the RRC signal including second RRC parameters indicating an SRS hopping pattern based on a determination that the SRS slot aggregation is enabled; performing, based on the SRS hopping pattern, the SRS slot aggregation to generate a super slot; and transmitting, to the BS, an SRS based on the super slot.

### CROSS-REFERENCE TO RELATED APPLICATIONS AND CLAIM OF PRIORITY

The present application claims priority to U.S. Provisional Patent Application No. 63/702,260, filed on Oct. 2, 2024. The contents of the above-identified patent documents are incorporated herein by reference.

### TECHNICAL FIELD

The present disclosure relates generally to wireless communication systems and, more specifically, the present disclosure relates to a sounding reference signal design and signaling in cellular communication systems including advanced cellular communication systems.

### BACKGROUND

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

### SUMMARY

The present disclosure relates to a sounding reference signal design and signaling in cellular communication systems.

In one embodiment, a user equipment (UE) in a wireless communication system is provided. The UE comprises a transceiver configured to receive, from a base station (BS), a radio resource control (RRC) signal including first RRC parameters. The UE further comprises a processor operably coupled to the transceiver, the processor configured to identify, based on the first RRC parameters, an aggregation flag indicating whether to enable sounding reference signal (SRS) slot aggregation, wherein: the transceiver is further configured to receive the RRC signal including second RRC parameters indicating an SRS hopping pattern based on a determination that the SRS slot aggregation is enabled, the processor is further configured to perform, based on the SRS hopping pattern, the SRS slot aggregation to generate a super slot, and the transceiver is further configured to transmit, to the BS, an SRS based on the super slot.

In another embodiment, a UE in a wireless communication system is provided. The UE comprises a transceiver configured to receive, from a BS, DCI including an indication. The UE further comprises a processor operably coupled to the transceiver, the processor configured to: determine, based on the indication included in DCI, whether to enable a rate matching operation in a SRS TZ, and identify, based on a determination that the rate matching operation is enabled, a type of the rate matching operation associated with an uplink transmission mode, wherein the transceiver is further configured to transmit, to the BS, the SRS in the SRS TZ based on the type of the rate matching operation.

In yet another embodiment, a method of UE in a wireless communication system is provided. The method comprises: receiving, from a BS, a RRC signal including first RRC parameters; identifying, based on the first RRC parameters, an aggregation flag indicating whether to enable SRS slot aggregation; receiving the RRC signal including second RRC parameters indicating an SRS hopping pattern based on a determination that the SRS slot aggregation is enabled; performing, based on the SRS hopping pattern, the SRS slot aggregation to generate a super slot; and transmitting, to the BS, an SRS based on the super slot.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example of wireless network according to embodiments of the present disclosure;

FIG. 2 illustrates an example of gNB according to embodiments of the present disclosure;

FIG. 3 illustrates an example of UE according to embodiments of the present disclosure;

FIGS. 4 and 5 illustrate examples of wireless transmit and receive paths according to this disclosure;

FIG. 6 illustrates an example of SRS design according to embodiments of the present disclosure;

FIG. 7 illustrates an example of SRS design based on slot aggregation, 16 SBs, 2×rep, and 5 ms period according to embodiments of the present disclosure;

FIG. 8 illustrates an example of rate matching according to embodiments of the present disclosure;

FIG. 9 illustrates another example of rate matching according to embodiments of the present disclosure;

FIG. 10 illustrates an example of SRS TZ RRC parameters and SRS TZ counter values according to embodiments of the present disclosure;

FIG. 11 illustrates an example of RRC parameters to configure UE-specific SRS parameters within SRS TZ and SRS counter values according to embodiments of the present disclosure; and

FIG. 12 illustrates a flowchart of method for a sounding reference signal design and signaling in cellular communication systems according to embodiments of the present disclosure.

### DETAILED DESCRIPTION

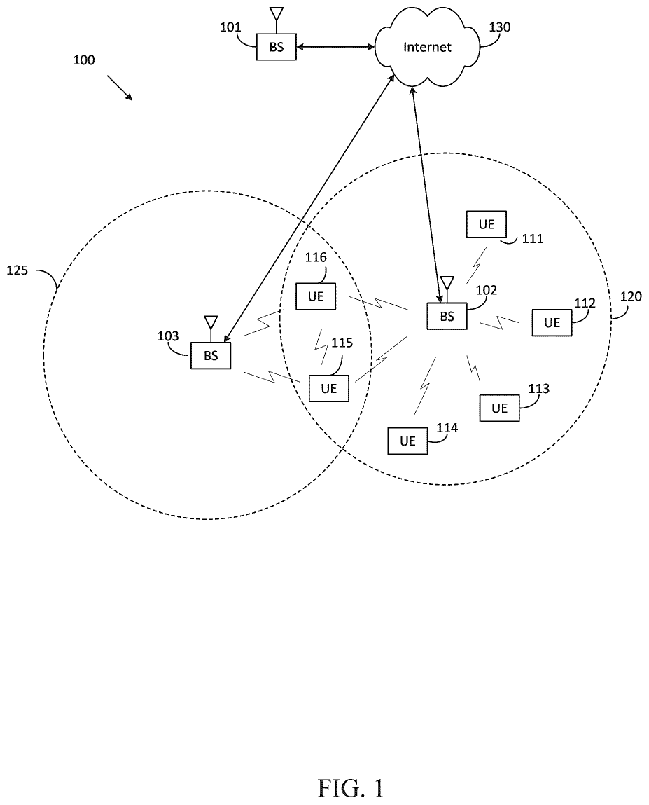

FIGS. 1-12, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems and to enable various vertical applications, 5G/NR communication systems have been developed and are being deployed. The 5G/NR communication system is considered to be implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

The following documents are hereby incorporated by reference into the present disclosure as if fully set forth herein: 3GPP TS 36.331 v16.3.0, “E-UTRA, Radio Resource Control (RRC) Protocol Specification”; and 3GPP TS 38.211 v16.4.0, “NR, Physical channels and modulation.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to the manner in which different embodiments may be implemented. Different embodiments of the present disclosure may be implemented in any suitably arranged communications system.

FIG. 1 illustrates an example of wireless network according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3rd generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered as a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for a dual pole antenna for increasing panel gain from limited aperture area for an operation for a sounding reference signal design and signaling in cellular communication systems. In certain embodiments, and one or more of the gNBs 101-103 includes circuitry, programing, or a combination thereof, for supporting an operation for configurations for a dual pole antenna for increasing panel gain from limited aperture area for supporting a sounding reference signal design and signaling in cellular communication systems.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

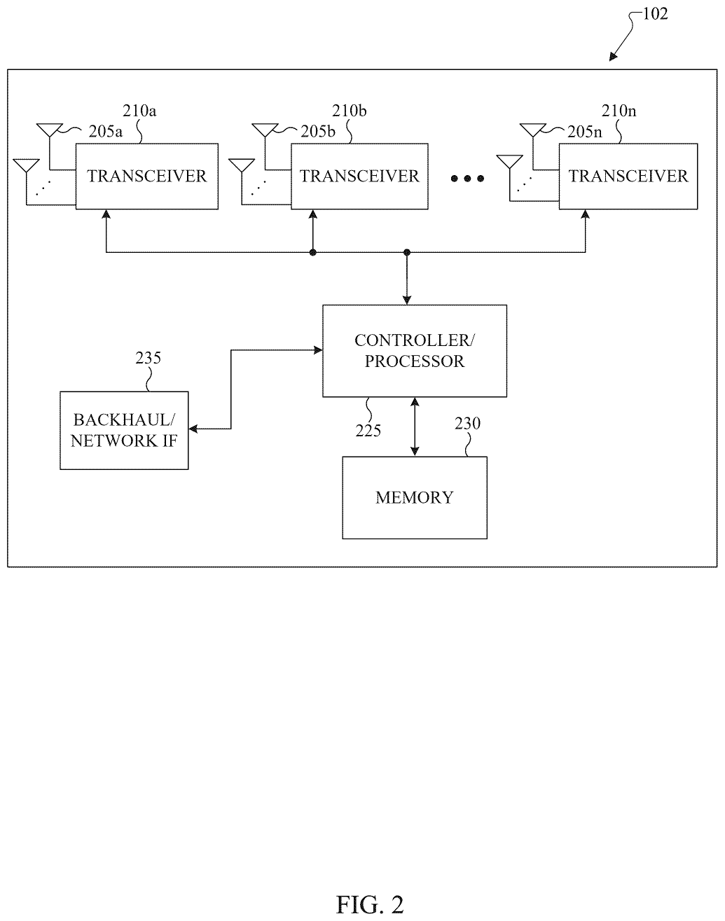

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming RF signals, such as signals transmitted by UEs in the network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of UL channel signals and the transmission of DL channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. Any of a wide variety of other functions could be supported in the gNB 102 by the controller/processor 225.

The controller/processor 225 is also capable of executing programs and other processes resident in the memory 230, such as processes for supporting a dual pole antenna for increasing panel gain from limited aperture area for a sounding reference signal design and signaling in cellular communication systems. The controller/processor 225 can move data into or out of the memory 230 as performed by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet). The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

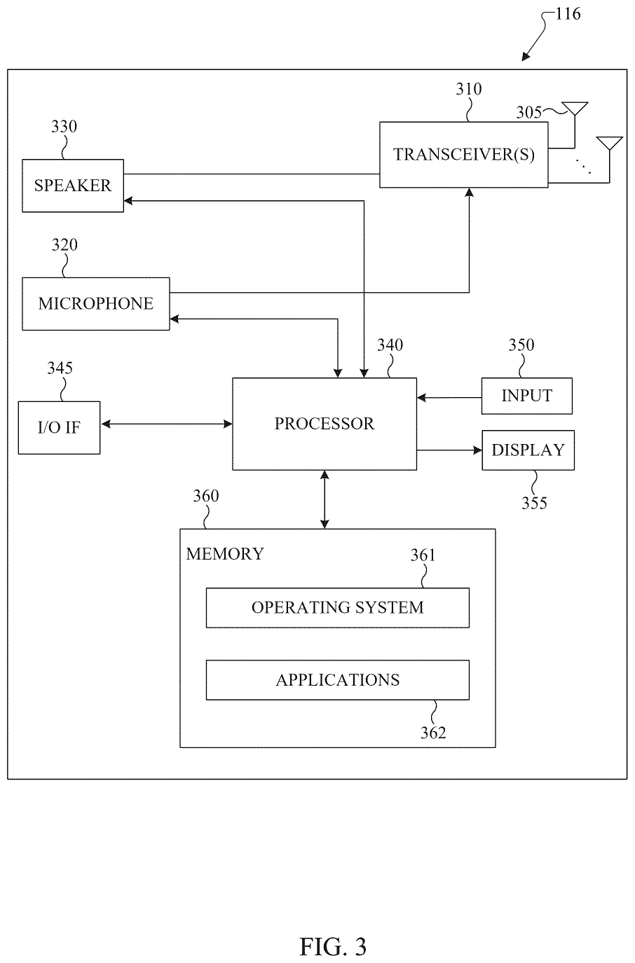

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, such as processes for a dual pole antenna for increasing panel gain from limited aperture area for supporting an operation of a sounding reference signal design and signaling in cellular communication systems.

The processor 340 can move data into or out of the memory 360 as performed by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350 and the display 355 which includes for example, a touchscreen, keypad, etc., The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

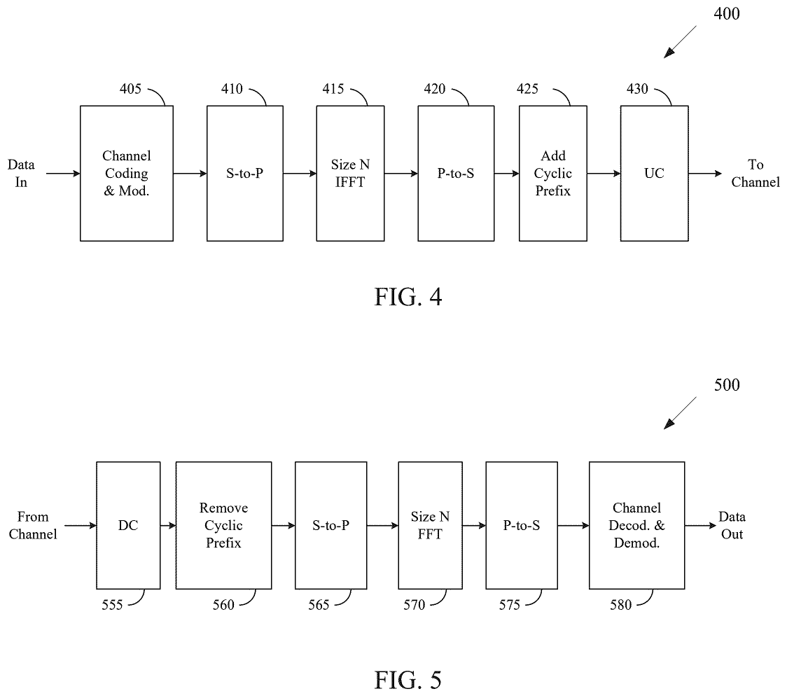

FIG. 4 and FIG. 5 illustrate example wireless transmit and receive paths according to this disclosure. In the following description, a transmit path 400 may be described as being implemented in a gNB (such as the gNB 102), while a receive path 500 may be described as being implemented in a UE (such as a UE 116). However, it may be understood that the receive path 500 can be implemented in a gNB and that the transmit path 400 can be implemented in a UE. In various embodiments, the receive path 500 can be implemented in a first UE and the transmit path 400 can be implemented in a second UE. In some embodiments, the transmit path 400 is configured to utilize a sounding reference signal design and signaling in cellular communication systems.

The transmit path 400 as illustrated in FIG. 4 includes a channel coding and modulation block 405, a serial-to-parallel (S-to-P) block 410, a size N inverse fast Fourier transform (IFFT) block 415, a parallel-to-serial (P-to-S) block 420, an add cyclic prefix block 425, and an up-converter (UC) 430. The receive path 500 as illustrated in FIG. 5 includes a down-converter (DC) 555, a remove cyclic prefix block 560, a serial-to-parallel (S-to-P) block 565, a size N fast Fourier transform (FFT) block 570, a parallel-to-serial (P-to-S) block 575, and a channel decoding and demodulation block 580.

As illustrated in FIG. 4, the channel coding and modulation block 405 receives a set of information bits, applies coding (such as a low-density parity check (LDPC) coding), and modulates the input bits (such as with quadrature phase shift keying (QPSK) or quadrature amplitude modulation (QAM)) to generate a sequence of frequency-domain modulation symbols.

The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116.

As illustrated in FIG. 5, the down converter 555 down-converts the received signal to a baseband frequency, and the remove cyclic prefix block 560 removes the cyclic prefix to generate a serial time-domain baseband signal. The serial-to-parallel block 565 converts the time-domain baseband signal to parallel time domain signals. The size N FFT block 570 performs an FFT algorithm to generate N parallel frequency-domain signals. The parallel-to-serial block 575 converts the parallel frequency-domain signals to a sequence of modulated data symbols. The channel decoding and demodulation block 580 demodulates and decodes the modulated symbols to recover the original input data stream.

Each of the gNBs 101-103 may implement a transmit path 400 as illustrated in FIG. 4 that is analogous to transmitting in the downlink to UEs 111-116 and may implement a receive path 500 as illustrated in FIG. 5 that is analogous to receiving in the uplink from UEs 111-116. Similarly, each of UEs 111-116 may implement the transmit path 400 for transmitting in the uplink to the gNBs 101-103 and may implement the receive path 500 for receiving in the downlink from the gNBs 101-103.

Each of the components in FIG. 4 and FIG. 5 can be implemented using only hardware or using a combination of hardware and software/firmware. As a particular example, at least some of the components in FIG. 4 and FIG. 5 may be implemented in software, while other components may be implemented by configurable hardware or a mixture of software and configurable hardware. For instance, the FFT block 570 and the IFFT block 415 may be implemented as configurable software algorithms, where the value of size N may be modified according to the implementation.

Furthermore, although described as using FFT and IFFT, this is by way of illustration only and may not be construed to limit the scope of this disclosure. Other types of transforms, such as discrete Fourier transform (DFT) and inverse discrete Fourier transform (IDFT) functions, can be used. It may be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIG. 4 and FIG. 5 illustrate examples of wireless transmit and receive paths, various changes may be made to FIG. 4 and FIG. 5. For example, various components in FIG. 4 and FIG. 5 can be combined, further subdivided, or omitted and additional components can be added according to particular needs. Also, FIG. 4 and FIG. 5 are meant to illustrate examples of the types of transmit and receive paths that can be used in a wireless network. Any other suitable architectures can be used to support wireless communications in a wireless network.

A sounding reference signal (SRS) is an uplink physical signal employed by a UE for uplink channel sounding, including channel quality estimation and channel prediction (CHPD). The SRS could be configured across the full-band to allow BS to perform UL channel estimate (regardless of UE's PUSCH transmission). An SRS plays an important role in a new radio (NR), as TDD is a dominant deployment and a BS can utilize the SRS-channel estimation result for different purposes. An SRS resource set is configured with an RRC parameter “usage” which can be set to beamManagement, codebook, nonCodebook, or antennaSwitching.

For time-varying channel scenarios, SRS-based channel prediction (e.g., Kalman filtering or machine learning methods) exploits current and past SRS measurements to forecast the future state of the channel. An accurate SRS-based CHPD is critical for different SRS use cases; in particular it helps in selecting the best precoding matrix that can optimize SINR with direct effect on data rates and reliability. Furthermore, UE mobility or higher doppler shifts severely degrades MU-MIMO performance as delayed channel estimates used for precoding may mismatch to actual channel, causing large MU interference. Therefore, precise channel prediction can be tailored to minimize interference with other UEs and match the actual channel. Moreover, better CHPD allows for more accurate beamforming, enhancing coverage and capacity in high frequency bands. Finally, precise CHPD can reduce latency associated with feedback loops and retransmissions.

According to 3GPP standard specification (e.g., TS 38.211 and TS 38.331), a BS sends an SRS configuration to a UE via an RRC signaling, defining one or more SRS resource sets; each SRS resource set contains one or more SRS resources; and each SRS resources correspond to one or more SRS ports. An SRS triggering mechanism and an SRS usage can be configured at an SRS resource set level. For an SRS transmission, the time domain behavior could be periodic, semi-persistent, or aperiodic.

NR SRS is based on Zadoff-Chu (ZC) sequences which have the desired property of having low cross-correlation and zero auto-correlation properties when the sequences and cyclic-shifts used are not identical. This property enables reuse of the same radio resource for multiplexing UEs or their different antenna ports by configuring the UE or antenna port with a different sequence or cyclic shift.

SRS symbols are mapped in such a way as to create a comb-like pattern with certain interval in frequency domain. Therefore, multiple SRS sequences can be interleaved (multiplexed) along the frequency domain, occupying the same OFDM symbols. In addition, coherent combination of SRS transmissions in a comb structure in subsequent OFDM symbols allows the effective transmit power to be enhanced without adjusting the transmit power itself. This makes it possible to enhances the SRS coverage of the UE without increasing the instantaneous transmit power, which means complexities of higher dynamic range of the amplifier can be avoided.

In NR, where the available radio resources are divided into resource elements (REs), i.e., one subcarrier (SC) in frequency and one OFDM in time, SRS transmitted by the UE can be orthogonalized by separating UEs or antenna ports by assigning them to different time, frequency, sequences, or cyclic shifts.

NR supports a frequency hopping, where it allows SRS to cover a wider bandwidth, providing more robust estimate of channel conditions across the entire frequency band and selecting the optimal precoding matrix. Also, an SRS frequency hopping can avoid persistent interference on certain frequency and time. It also helps BS to more efficiently utilize available spectral resources among UEs. For an SRS frequency allocation, the appropriate 3GPP parameters (e.g., CSRS, BSRS, and BHop) for the SRS bandwidth and frequency hopping configuration are given in 3GPP standard specification TS 38.211. The BS can configure the UE with the SRS parameters e.g., transmissionComb, repetitionFactor, periodicityAndOffset-p.

It is expected that SRS based channel prediction (CHPD) accuracy over higher frequency bands (e.g., 7 GHZ to 24 GHz) could become worse compared to NR FRI (Sub-6 GHZ). Poor SRS coverage and higher Doppler shifts are two main factors on SRS performance degradation in such frequency bands. For instance, pathloss (PL) at 7 GHz is about 6 dB higher than PL at 3.5 GHz for same distance (assuming PL exponent of 2); furthermore, noise figure (NF) at 7 GHz is about 2 dB higher than NF at 3.5 GHZ (e.g., 3GPP standard specification TR 38.802). Therefore, 8 dB SNR loss needs to be compensated to achieve the same SRS coverage in 7 GHz as 3.5 GHz for the same BW.

To achieve similar SRS coverage and mobility as 3.5 GHZ, new SRS designs and signaling are provided. From a system-design point of view, an SRS design can have significant impact on SRS performance (e.g., coverage, mobility, capacity and overhead). A BS can improve the accuracy and reliability of channel estimates by averaging the repeated SRS transmissions (specified by repetition factor). This is particularly beneficial in challenging conditions such as low SNR environment (cell edge) or high mobility scenarios where the channel may be rapidly changing. Although a repetition of SRS signals over multiple OFDM symbols can help with reducing coverage loss due to higher PL, this could come at cost of lower PUSCH opportunity for given UE. In addition, the SRS periodicity determines how often the SRS is transmitted, by increasing SRS periodicity, the doppler resolution could be lowered but number of sub-bands can be increased and hence, the coverage can be improved.

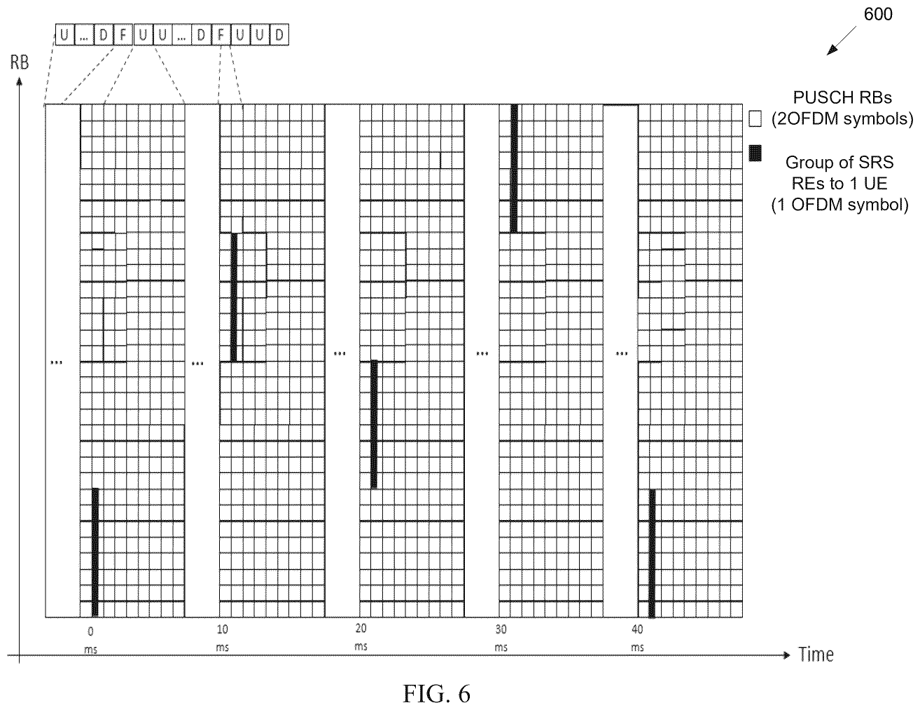

FIG. 6 illustrates an example of SRS design 600 according to embodiments of the present disclosure. An embodiment of the SRS design 600 shown in FIG. 6 is for illustration only.

FIG. 6 depicts a baseline SRS design for 3.5 GHz NR, TDD config of 8:2, 100 MHZ with 272 RBs. In the time-frequency grid depicted in FIG. 6, every 2 units in the frequency domain corresponds to 17 RBs. In addition, each unit in the time domain represents 2 OFDM symbols for UL REs. For baseline, each sub-band has 68 RBs and each SRS symbol is repeated twice, with SRS periodicity of 10 ms (20 slots).

In the present disclosure, the following embodiments are provided: (i) SRS slot Aggregation is introduced in which UL REs from F and U slots are aggregated to obtain a super slot for SRS transmission; the presence of SRS slot aggregation is indicated to the UE via RRC signaling, by setting the flag superslot. If this flag is set, an SRS hopping pattern is indicated to the UE by setting additional RRC parameters; (ii) rate matching for PUSCH transmission can be performed in which a UE may rate match around SRS transmission zones. For this purpose, single-bit DCI_RM_bit indicates the UE to perform rate matching or not for duration of corresponding OFDM symbol. In case DCI_RM_bit=1, either full-band or partial-band rate matching with respect to BWP or system BW is performed (depending on value of RRC IE of UL_RM_mode); and (iii) SRS transmission xone (TZ) is provided and defined in terms of the aggregated super slots; this could be signaled to UEs via RRC. On top of SRS TZ, UE-specific SRS allocation may be indicated separately to each UE configured for SRS via RRC.

The provided methods allow backward compatibility with the existing NR standard and the sequence generation procedure is not altered.

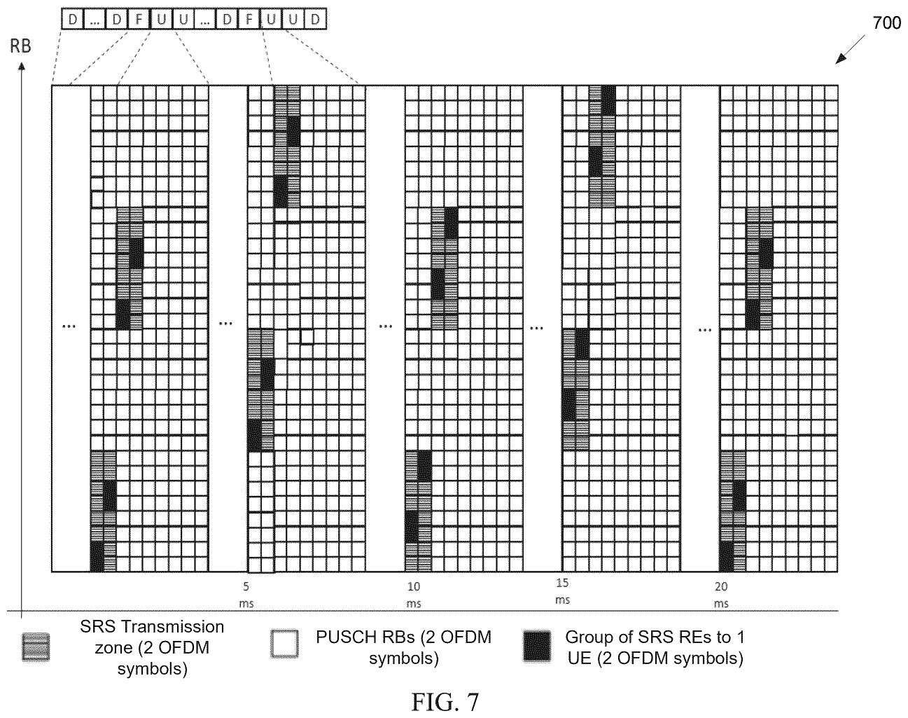

To compensate for higher SRS pathloss in higher frequency bands, SRS sub-band (SB) hopping is performed (with smaller bandwidth than system bandwidth). In addition, in scenarios where large system bandwidth (e.g., 200 MHz) to be sounded, this could result in higher SRS duty cycle and reduce CHPD accuracy. In order to accommodate multi-SB hopping while maintaining SRS coverage and Doppler requirements, notion of an uplink “superslot” is provided, where the UL symbols from F slot are aggregated with U slot. FIG. 7 illustrates an example of SRS slot aggregation.

FIG. 7 illustrates an example of SRS design based on slot aggregation, 16 SBs, 2×rep, and 5 ms period 700 according to embodiments of the present disclosure. An embodiment of the SRS design based on slot aggregation, 16 SBs, 2×rep, and 5 ms period 700 shown in FIG. 7 is for illustration only.

SRS slot aggregation could help to utilize UL resources efficiently and more flexibly for SRS transmission. In addition, it can reduce the SRS signaling overhead by preventing configuring multiple SRS resource sets for F and U slots, independently. The presence of SRS slot aggregation can be indicated to the UE by setting the flag superslot.

The 3GPP standard specification defines a number of consecutive OFDM symbols for UE's SRS symbols as N_{symb}^{SRS}∈{1, . . . , 14}. For SRS slot aggregation, set of feasible nrofSymbols is extended from 14 to N_{symb}^{slot}+u_{sym} where u_{sym} is nrofUplinkSymbols in F slot; e.g., 4. In addition, current 3GPP defines SRS offset's range as l_{offset}∈{0, . . . , 13}, counts symbols backwards from the end of the slot. With SRS slot aggregation, l_{offset} 's range could be modified to l_{offset}∈{0, . . . , N_{symb}^{slot}+u_{sym}−1}, counts symbols from the beginning of the UL part of F-slot. TABLE 1 summarizes the RRC parameters utilized for the SRS slot aggregation. These parameters could be utilized if the superslot flag is set.

TABLE 1
Relevant RRC parameters for provided SRS slot aggregation

| Symbol | Parameter name | New Definition |
|---|---|---|
| ${N}_{s y m b}^{S R S}$ | nrofSymbols | ${N}_{s y m b}^{S R S} ∈ \{ 1 , … , {N}_{s y m b}^{slot} + {u}_{s y m} \} as a$ |
| | | number of consecutive OFDM symbols |
| | | for UE’s SRS symbols in aggregated |
| | | slot; (u_{sym} is nrofUplinkSymbols in F |
| | | slot; e.g., 4) |
| l_{offset} | startPosition | ${l}_{offset} ∈ \{ 0 , … , {N}_{s y m b}^{slot} + {u}_{s y m} - 1 \}$ |
| | | counts symbols from the beginning of |
| | | the UL part of F-slot |
| n_{SRS} | $( \frac{{N}_{slot}^{frame , μ} {n}_{f} + {n}_{s , f}^{μ} - {T}_{offset}}{{T}_{S R S}} ) \cdot ( \frac{{N}_{s y m b}^{S R S}}{R} ) + ⌊ \frac{{l}^{′}}{R} ⌋$ $0 \leq {l}^{′} \leq {N}_{s y m b}^{S R S} - 1$ | SRS transmission count: Counts the number of SRS transmissions in time domain for 1 UE $slot aggregation starts with F - slot ( {n}_{s , f}^{μ}$ corresponds to F-slot) |
| | Satisfying, | |
| | ${N}_{slot}^{frame , μ} {n}_{f} + {n}_{s , f}^{μ} - {T}_{offset} mod {T}_{S R S} = 0$ | |

In the 3GPP standard specification (e.g., TS 38.211), b_{SRS} is configured in such a way that if B_{SRS}≤b_{SRS}, a frequency hopping is disabled and vice versa. In one embodiment, it is provided not to utilize b_{SRS} and instead in a Table based SRS configuration approach by signaling B_{SRS}=0, implying no frequency hopping or in case of a none-Table based approach m_{SRS,0}, can be signalized equal to number of RBs.

In one embodiment of SRS design based on SRS slot aggregation (as an example), an SRS signal is generated to cover full-band transmission (200 MHZ, 272 RB), utilizing frequency-hopping feature, enabling multi-user/port transmissions by multiplexing using time, frequency and cyclic shifts. The provided example design facilitates SRS channel estimation and prediction at BSs in the UL by utilizing SB size of 17 RBs and repetition factor of 2. The whole band is sounded within 20 ms (SRS duty cycle) using TDD configuration of 8:2. This design utilizes SRS slot aggregation by exploiting UL symbols from both F (last four symbol) and U slots (first 4 symbols of first U slot).

FIG. 7 illustrates this design. The individual SBs can be coherently combined at BS to obtain a full-band channel estimate and prediction. To achieve the above effect, inter- and intra-slot hop patterns for transmission of uplink SRS are utilized. As illustrated in FIG. 7, SRS design is provided based on slot aggregation, 16 SBs, 2×rep, 5 ms period. In each aggregated slot, 4 SBs are sounded (two from F-slot and two from U-slot).

The provided SRS rate matching is applied in a UE side, on the set of UL REs. It prevents a UL data transmission, (i.e., PUSCH) around of SRS transmission zone (frequency and time region that the SRS of UEs in the cell could be scheduled). A target UE could exploit appropriate RRC parameters to calculate the SRS transmission zone and if single-bit DCI is set by NW (DCI_RM_bit=1), a UE may perform rate matching around of SRS transmission zone. Rate matching is performed to transmit UE's PUSCH transmission around of SRS transmission zone in the same cell sharing same carrier. This prevents interference on SRS reception in the cell by the PUSCH of UEs.

For this purpose, a UE could utilize provided RRC parameters, given in TABLE 2 to realize an SRS transmission zone (detailed discussion on how to configure SRS transmission zone is given is next section “configuring SRS transmission zone”). A UL rate matching could be performed, regardless if a UE is configured with SRS transmission or not. An RRC IE of UL_RM_mode is provided to inform UEs in the cell which rate matching method to be utilized.

In the present disclosure, two methods are provided for SRS rate matching, in which NW can configure one of them for the UE, semi-statically.

In one embodiment, a full-band rate matching (UL_RM_mode=0) is provided. This method is enabled by muting all of PUSCH transmissions in the cell over full-carrier bandwidth or BWP of each OFDM symbol that carries periodic SRS transmission; guaranteeing that no PUSCH transmission is performed in the frequency domain; protecting SRS symbols from any interference due to potential PUSCH leakage. Moreover, if a UE is scheduled with PUSCH, before transmitting PUSCH, the UE may calculate the SRS transmission zone, and then rate match its PUSCH transmission around of the SRS transmission zone. A UL_RM_mode can be configured to 0 to indicate full-band rate matching.

If transfer precoding is configured for UL, and if NW configures DCI_RM_bit=1, a UE may follow full-band rate matching (regardless of UL_RM_mode).

For a non-periodic SRS transmission, a NW can still request a UE to mute its PUSCH transmission and apply full-band rate matching with a dynamic configuration of DCI_RM_bit.

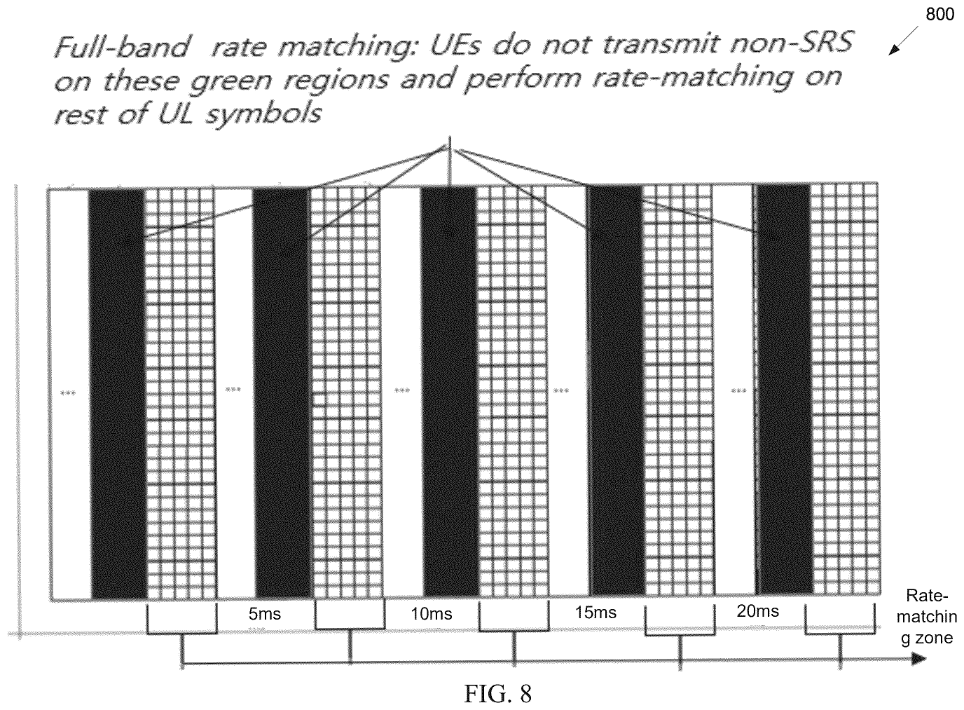

FIG. 8 illustrates an example of rate matching 800 according to embodiments of the present disclosure. An embodiment of the rate matching 800 shown in FIG. 8 is for illustration only.

FIG. 8 illustrates full-band rate matching. As shown in the FIG. 8, in those UL OFDM symbols (first 8 symbols) that SRS REs or SRS transmission zone are configured, a UE mute any PUSCH transmission; and UEs perform rate matching across non-SRS REs for its PUSCH transmission (rest of OFDM symbols in the slot).

In one embodiment, a partial-band rate matching (UL_RM_mode=1) is provided. In this embodiment, a UE may not send any UL data transmissions on those REs (subcarriers) that are allocated for SRS transmissions in the cell. In contrast to full-band rate matching, UEs still can transmit PUSCH in REs of those OFDM symbols that do not carry SRS. If the UE is scheduled to transmit the PUSCH on SRS REs, the UE may perform rate matching on none-SRS REs. This is spectrally-efficient approach. A UL_RM_mode can be set to 1 to indicate Partial-band rate matching.

In case that CP-OFDM is utilized for UL Tx and NW configures DCI_RM_bit=1, depending on UL_RM_mode, a UE could perform partial or full band rate matching around of SRS transmission zone.

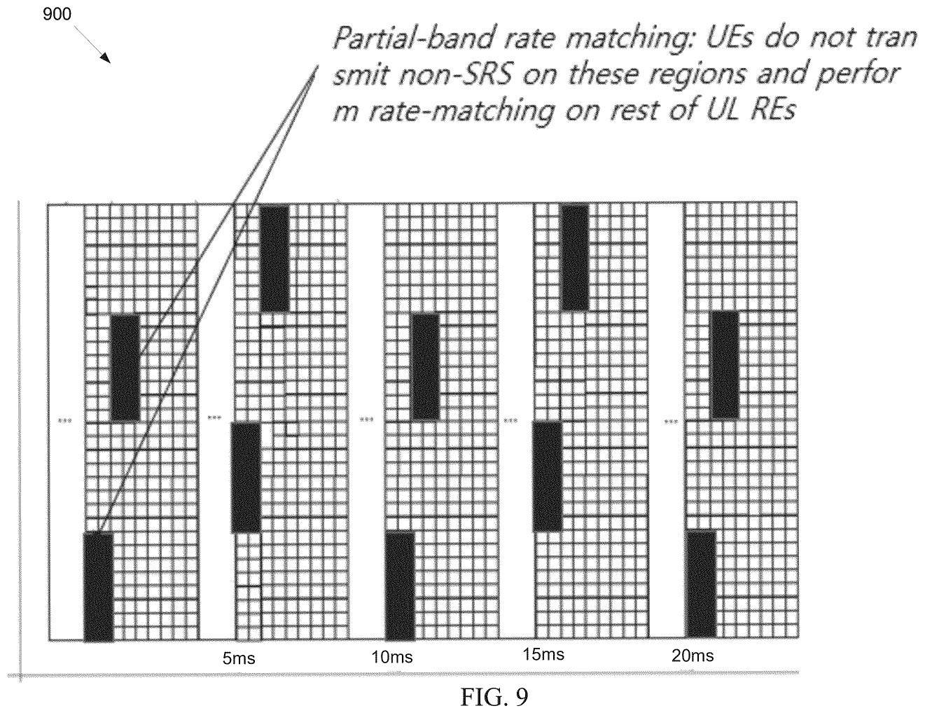

FIG. 9 illustrates another example of rate matching 900 according to embodiments of the present disclosure. An embodiment of the rate matching 900 shown in FIG. 9 is for illustration only. FIG. 9 illustrates the partial-band rate matching that UEs are not transmitting any PUSCH transmission over SRS transmission zone.

A UL rate matching can be performed regardless of a UE is configured with SRS transmission or not. A DCI_RM_bit's default value is zero and by default, no rate matching is performed for the UE, and the UE follows NW scheduling grants, accordingly. However, for DCI_RM_bit=1, the UE performs rate matching around of SRS transmission zone.

Various aspects described herein generally relate to SRS and in particular determining the location of SRS REs in a time and frequency domain for an SRS resource of one SRS resource set defined in the SRS configuration; the extension to more ports and SRS resources sets are straightforward.

To signal SRS transmission zone (TZ), a NW could utilize a provided RRC parameter nrofSymbolsTZ

$${N}_{symb}^{SRS , TZ} ∈ \{ 1 , … , {N}_{symb}^{slot} + {u}_{sym} \}$$

as a number of consecutive OFDM symbols for SRS TZ in the aggregated slot; (u_{sym} is nrofUplinkSymbols in F slot; e.g., 4); also provided RRC parameter of startPositionTZ, l_{offset,TZ}∈

$$\{ 0 , … , {N}_{symb}^{slot} + {u}_{sym} - 1 \}$$

which counts symbols from the beginning of the UL part of F-slot, and determines the start symbol of SRS TZ; provided RRC parameter of SBTZWidth informs UE the width of TZ's SB in terms of OFDM symbol.

The notion of “SRSTZ” is provided when the SRS TZ is configured by a NW and a UE may follow it. The presence of SRS TZ may be indicated to the UE by setting the flag SRSTZ. TABLE 2 summarizes the RRC parameters utilized for configuring the SRS TZ. These parameters could be utilized if the SRSTZ flag is set.

For an SRS TZ hopping and bandwidth configuration, the appropriate 3GPP parameters (e.g., CSRS_TZ, BSRS_TZ, and BHop_TZ) can be utilized by reusing 3GPP standard specification TS 38.211. To have more flexibility, a none-Table based approach to construct SRS TZ can be applied, where a NW configures following SRS TZ parameters m_{SRS0, TZ}, N_{1,TZ}, N_{2,TZ}, N_{3,TZ}, B_{SRS,TZ} individually via RRC configurations. The provided RRC parameter freqDomainPositionTZ determines the frequency offset of SRS TZ, which is labeled by the count of SRS TZ's SB hopping (n_{SRS,TZ}).

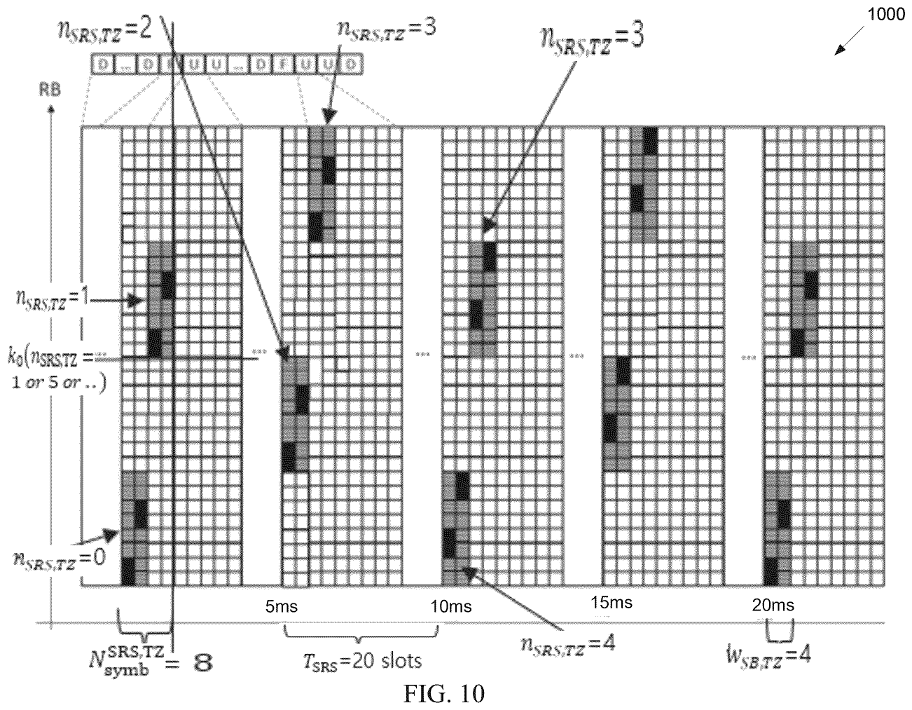

FIG. 10 illustrates an example of SRS TZ RRC parameters and SRS TZ counter values 1000 according to embodiments of the present disclosure. An embodiment of the SRS TZ RRC parameters and SRS TZ counter values 1000 shown in FIG. 10 is for illustration only. FIG. 10 illustrates the provided parameters and an example of SRS TZ counter values.

TABLE 2
RRC parameters for configuring SRS transmission zone

| Symbol | Parameter name | Definition |
|---|---|---|
| ${N}_{s y m b}^{SRS , TZ}$ | nrofSymbolsTZ | ${N}_{s y m b}^{SRS , TZ} ∈ \{ 1 , … , {N}_{s y m b}^{slot} + {u}_{s y m} \} as$ |
| | | a number of consecutive OFDM |
| symb | | symbols for SRS transmission |
| | | zone in aggregated slot; (u_{sym} is |
| | | nrofUplinkSymbols in F slot; e.g., |
| | | 4) |
| l_{offset,TZ} | startPositionTZ | ${l}_{offset , T Z} ∈ \{ 0 , … , {N}_{s y m b}^{slot} + {u}_{s y m} - 1 \}$ |
| | | counts symbols from the |
| | | beginning of the UL part of F-slot |
| W_{SB,TZ} | SBTZWidth | width of SRS transmission zone’s |
| | | SB in terms of OFDM symbol |
| m_{SRS, TZ}, N_{1,TZ}, | freqHoppingTZ | none-Table based approach to |
| N_{2,TZ}, N_{3,TZ} , B_{SRS,TZ} | | construct SRS transmission zone |
| n_{RRC,TZ} | freqDomainPositionTZ | RRC parameters to offset the SRS |
| | | TZ’s frequency location, specified |
| | | as a number of 4 RBs |
| n_{SRS, TZ} | $( \frac{{N}_{slot}^{frame , μ} {n}_{f} + {n}_{s , f}^{μ} - {T}_{offset}}{{T}_{S R S}} ) \cdot ( \frac{{N}_{s y m b}^{SRS , TZ}}{{w}_{SB , TZ}} ) + ⌊ \frac{{l}^{′ TZ}}{{w}_{SB , TZ}} ⌋$ $0 \leq {l}^{′ TZ} \leq {N}_{s y m b}^{S R S , T Z} - 1$ | SRS transmission count: counts the number of SRS TZ in time domain. |
| | Satisfying, | |
| | ${N}_{slot}^{frame , μ} {n}_{f} + {n}_{s , f}^{μ} - mod {T}_{SRS} = 0$ | |
| | $and {n}_{s , f}^{μ} corresponds$ | |
| | to F-slot | |

FIG. 10 illustrates relevant SRS TZ RRC parameters and SRS TZ counter values.

Define, Sᵤ={n_{SRS,TZ}|k₀(n_{SRS,TZ})=k₀(u)} as the set of TZs with same frequency offset (k₀), where

$$0 \leq u \leq U - 1 , U = {\prod }_{b = 1}^{{B}_{SRS , TZ}} {N}_{b , TZ}$$

is number of disjoint TZ SBs in frequency domain and k₀(n_{SRS,TZ}) is the frequency location of n_{SRS,TZ} th SRS TZ. n_{SRS, u} is defined as the SRS counter for the u^{th} disjoint SRS TZ's SB. If n_{SRS,TZ}∈Sᵤ, n_{SRS, u} to be utilized as an SRS counter.

$$F = {\prod }_{b = 1}^{{B}_{SRS}} {N}_{b}$$

is number of UE specific SBs in frequency domain to cover whole band of single TZ. n_{SRS, u} can be formulated as

$${n}_{SRS , u} = ( \frac{{N}_{slot}^{frame , μ} {n}_{f} + {n}_{s , f}^{μ} - {T}_{offset}}{{xT}_{SRS}} ) \cdot ( \frac{{N}_{symb}^{SRS}}{R} ) + ⌊ \frac{{l}^{′}}{R} ⌋ ,$$

$${N}_{slot}^{frame , μ} {n}_{f} + {n}_{s , f}^{μ} - {T}_{offset} mod {xT}_{SRS} = 0 , 0 \leq {l}^{′} \leq {N}_{symb}^{SRS} - 1 .$$

The nrofSymbols

$${N}_{symb}^{SRS} ∈ \{ 1 , … , {W}_{SB , TZ} \}$$

can be re-defined as a number of consecutive OFDM symbols for UE's SRS symbols within SRS TZ. In addition, startPosition l_{offset}∈

$$\{ 0 , … , {N}_{sy mb}^{slot} - 1 \}$$

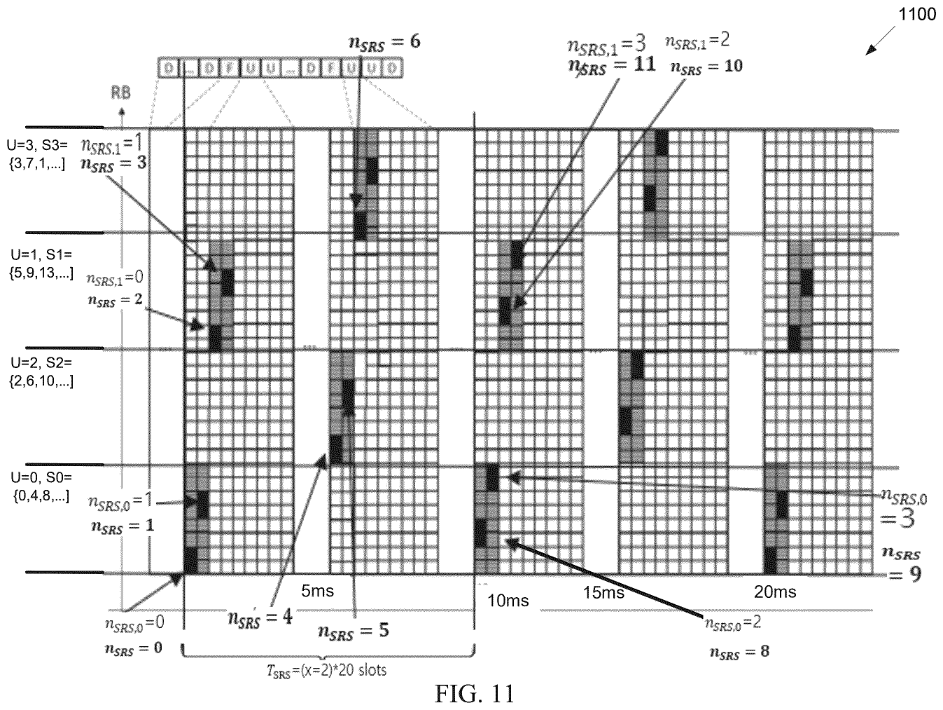

can be interpreted as count of symbols from the beginning of SRS TZ. FIG. 11 illustrates the provided parameters and an example of SRS counters.

FIG. 11 illustrates an example of RRC parameters to configure UE-specific SRS parameters within SRS TZ and SRS counter values 1100 according to embodiments of the present disclosure. An embodiment of the RRC parameters to configure UE-specific SRS parameters within SRS TZ and SRS counter values 1100 shown in FIG. 11 is for illustration only.

FIG. 11 illustrates relevant RRC parameters to configure UE-specific SRS parameters within SRS TZ and SRS counter values (U=4, F=4, and x=2).

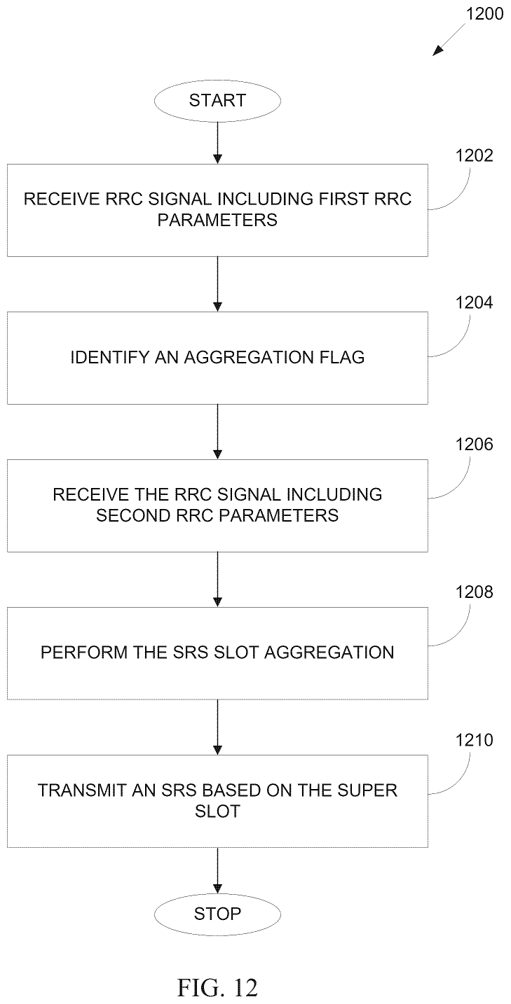

FIG. 12 illustrates a flowchart of UE method 1200 for a sounding reference signal design and signaling in cellular communication systems according to embodiments of the present disclosure. The method 1200 may be performed by a UE (e.g., 111-116 as illustrated in FIG. 1). An embodiment of the method 1200 shown in FIG. 12 is for illustration only. One or more of the components illustrated in FIG. 12 can be implemented in specialized circuitry configured to perform the noted functions or one or more of the components can be implemented by one or more processors executing instructions to perform the noted functions.

As illustrated in FIG. 12, the UE method 1200 beings at step 1202. In step 1202, a UE receives, from a BS, an RRC signal including first RRC parameters.

Subsequently, in step 1204, the UE identifies, based on the first RRC parameters, an aggregation flag indicating whether to enable SRS slot aggregation.

Subsequently, in step 1206, the UE receives the RRC signal including second RRC parameters indicating an SRS hopping pattern based on a determination that the SRS slot aggregation is enabled.

Next, the UE in step 1208 performs, based on the SRS hopping pattern, the SRS slot aggregation to generate a super slot.

Finally, the UE in step 1210 transmits, to the BS, an SRS based on the super slot.

In one embodiment, the UE generates the super slot by aggregating UL symbols from an F slot with a UL slot in UL slots.

In one embodiment, the UE receives, from the BS, the RRC signal for the SRS slot aggregation, the RRC signal indicating a range of a number of SRS symbols and an offset value for the super slot.

In such embodiments, the range of the number of SRS symbols comprises consecutive OFDM symbols for the SRS symbols included in the super slot; and the offset value for an uplink slot indicates a starting instance of a slot at beginning of an uplink part of an F slot in the super slot.

In one embodiment, the UE receives the RRC signal including a TZ flag indicating whether to enable an SRS TZ.

In one embodiment, the UE receives the RRC signal including a range of a number of SRS symbols for the SRS TZ, an offset value for the SRS TZ, a width for the SRS TZ, and a frequency domain position for the SRS TZ.

In such embodiments, the range of the number of SRS symbols for the SRS TZ comprises consecutive OFDM symbols in the super slot; the offset value for the SRS TZ indicates a starting instance of a slot at beginning of an uplink part of an F slot in the super slot; the width for the SRS TZ indicates a number of OFDM symbols allocated to an SRS sub-band (SB) of the SRS TZ; and the frequency domain position for the SRS TZ indicate an offset for a frequency location of the SRS TZ.

The above flowcharts illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, step, or function is an essential element that must be included in the claims scope. The scope of patented subject matter is defined by the claims.

What is claimed is:

1. A user equipment (UE) in a wireless communication system, the UE comprising:
a transceiver configured to receive, from a base station (BS), a radio resource control (RRC) signal including first RRC parameters; and
a processor operably coupled to the transceiver, the processor configured to identify, based on the first RRC parameters, an aggregation flag indicating whether to enable sounding reference signal (SRS) slot aggregation,
wherein:
the transceiver is further configured to receive the RRC signal including second RRC parameters indicating an SRS hopping pattern based on a determination that the SRS slot aggregation is enabled,
the processor is further configured to perform, based on the SRS hopping pattern, the SRS slot aggregation to generate a super slot, and
the transceiver is further configured to transmit, to the BS, an SRS based on the super slot.

2. The UE of claim 1, wherein the processor is further configured to generate the super slot by aggregating uplink (UL) symbols from a flexible (F) slot with a UL slot in UL slots.

3. The UE of claim 1, wherein the transceiver is further configured to receive, from the BS, the RRC signal for the SRS slot aggregation, the RRC signal indicating a range of a number of SRS symbols and an offset value for the super slot.

4. The UE of claim 3, wherein:
the range of the number of SRS symbols comprises consecutive orthogonal frequency division multiplexing (OFDM) symbols for the SRS symbols included in the super slot; and
the offset value for an uplink slot indicates a starting instance of a slot at beginning of an uplink part of a flexible (F) slot in the super slot.

5. The UE of claim 1, wherein the transceiver is further configured to receive the RRC signal including a transmission zone (TZ) flag indicating whether to enable an SRS TZ.

6. The UE of claim 5, wherein the transceiver is further configured to receive the RRC signal including a range of a number of SRS symbols for the SRS TZ, an offset value for the SRS TZ, a width for the SRS TZ, and a frequency domain position for the SRS TZ.

7. The UE of claim 6, wherein:
the range of the number of SRS symbols for the SRS TZ comprises consecutive orthogonal frequency division multiplexing (OFDM) symbols in the super slot;
the offset value for the SRS TZ indicates a starting instance of a slot at beginning of an uplink part of an F slot in the super slot;
the width for the SRS TZ indicates a number of orthogonal frequency division multiplexing (OFDM) symbols allocated to an SRS sub-band (SB) of the SRS TZ; and
the frequency domain position for the SRS TZ indicate an offset for a frequency location of the SRS TZ.

8. A user equipment (UE) in a wireless communication system, the UE comprising:
a transceiver configured to receive, from a base station (BS), downlink control information (DCI) including an indication; and
a processor operably coupled to the transceiver, the processor configured to:
determine, based on the indication included in DCI, whether to enable a rate matching operation in a sounding reference signal (SRS) transmission zone (TZ), and
identify, based on a determination that the rate matching operation is enabled, a type of the rate matching operation associated with an uplink transmission mode,
wherein the transceiver is further configured to transmit, to the BS, the SRS in the SRS TZ based on the type of the rate matching operation.

9. The UE of claim 8, wherein:
the uplink transmission mode comprises a discrete Fourier transform-spread-orthogonal frequency division multiplexing (DFT-S-OFDM) mode and an OFDM mode, and
the type of the rate matching operation comprises a full-band rate matching operation and a partial-band rate matching operation.

10. The UE of claim 9, wherein the processor is further configured to:
perform the full-band rate matching operation when the uplink transmission mode is configured as the DFT-S-OFDM mode; or
perform the partial-band rate matching operation when the uplink transmission mode is configured as the OFDM mode.

11. The UE of claim 8, wherein:
the transceiver is further configured to receive the RRC signal including a mode indication indicating the type of the rate matching operation for transmitting the SRS;
the processor is further configured to identify, based on the mode indication, the type of the rate matching operation for transmitting the SRS; and
the type of the rate matching operation comprises a full-band rate matching operation and a partial-band rate matching operation.

12. The UE of claim 8, wherein the transceiver is further configured to receive the RRC signal including a TZ flag indicating whether to enable the SRS TZ.

13. The UE of claim 8, wherein the transceiver is further configured to receive the RRC signal including a range of a number of SRS symbols for the SRS TZ, an offset value for the SRS TZ, a width for the SRS TZ, and a frequency domain position for the SRS TZ.

14. The UE of claim 13, wherein:
the range of the number of SRS symbols for the SRS TZ comprises consecutive orthogonal frequency division multiplexing (OFDM) symbols in uplink slots;
the offset value for the SRS TZ indicates a starting instance of a slot at beginning of an uplink part of an F slot in the uplink slots;
the width for the SRS TZ indicates a number of OFDM symbols allocated to an SRS sub-band (SB) of the SRS TZ; and
the frequency domain position for the SRS TZ indicates an offset for a frequency location of the SRS TZ.

15. A method of user equipment (UE) in a wireless communication system, the method comprising:
receiving, from a base station (BS), a radio resource control (RRC) signal including first RRC parameters;
identifying, based on the first RRC parameters, an aggregation flag indicating whether to enable sounding reference signal (SRS) slot aggregation;
receiving the RRC signal including second RRC parameters indicating an SRS hopping pattern based on a determination that the SRS slot aggregation is enabled;
performing, based on the SRS hopping pattern, the SRS slot aggregation to generate a super slot; and
transmitting, to the BS, an SRS based on the super slot.

16. The method of claim 15, further comprising generating the super slot by aggregating uplink (UL) symbols from a flexible (F) slot with a UL slot in UL slots.

17. The method of claim 15, further comprising receiving, from the BS, the RRC signal for the SRS slot aggregation, the RRC signal indicating a range of a number of SRS symbols and an offset value for the super slot.

18. The method of claim 17, wherein:
the range of the number of SRS symbols comprises consecutive orthogonal frequency division multiplexing (OFDM) symbols for the SRS symbols included in the super slot; and
the offset value for an uplink slot indicates a starting instance of a slot at beginning of an uplink part of a flexible (F) slot in the super slot.

19. The method of claim 15, further comprising receiving the RRC signal including a transmission zone (TZ) flag indicating whether to enable an SRS TZ.

20. The method of claim 15, further comprising receiving the RRC signal including a range of a number of SRS symbols for the SRS TZ, an offset value for the SRS TZ, a width for the SRS TZ, and a frequency domain position for the SRS TZ,
wherein:
the range of the number of SRS symbols for the SRS TZ comprises consecutive orthogonal frequency division multiplexing (OFDM) symbols in the super slot;
the offset value for the SRS TZ indicates a starting instance of a slot at beginning of an uplink part of an F slot in the super slot;
the width for the SRS TZ indicates a number of orthogonal frequency division multiplexing (OFDM) symbols allocated to an SRS sub-band (SB) of the SRS TZ; and
the frequency domain position for the SRS TZ indicate an offset for a frequency location of the SRS TZ.
